(19) United States
(12) Patent Application Publication
(10) Pub. No.: US 2014/0052558 A1
(43) Pub. Date: Feb. 20, 2014

(54) METHODS AND APPARATUS FOR SHARING DIGITAL BOOKS AND OTHER DIGITAL MEDIA OBJECTS

(71) Applicant: ReDigi, Inc., (US)

(72) Inventors: Lawrence S Rogel, Brookline, MA (US); Jonathan Lin, Boston, MA (US); Xiao Zhou, Roxbury Crossing, MA (US); John M. Ossenmacher, Balboa Island, CA (US)

(73) Assignee: REDIGI, INC., Boston, MA (US)

(21) Appl. No.: 13/838,691

(22) Filed: Mar. 15, 2013

Related U.S. Application Data
(60) Provisional application No. 61/661,325, filed on Jun. 18, 2012.

(51) Int. Cl. H04L 29/08; G06Q 30/06

(52) U.S. Cl. CPC H04L 67/32; G06Q 30/0601
USPC 705/26.1; 709/217

(57) ABSTRACT

The invention provides in some aspects a digital data system that includes a first digital data device that, in order to transfer a digital media object to a second digital data device, transfers to that second digital data device a virtual machine embodying that digital media object. Those digital data devices may be, according to aspects of the invention, any of mainframe computers, minicomputers, workstations, desktop computers, portable computers, tablet computers, smart phones, personal digital assistants, eReaders, video consoles, movie players and other dedicated digital data devices. And, according to further aspects of the invention, the digital media object comprises a creative work, such as, by way of nonlimiting example, a song, video, movie, book, story, article, document, still image, video game, software, or combination thereof

### BACKGROUND OF THE INVENTION

This application claims the benefit of filing of U.S. patent application Ser. No. 61/661,325, filed Jun. 18, 2012, the teachings of which are incorporated herein by reference.

The invention pertains to digital media handling and, more particularly, for example, to the transfer of digital media objects and/or ownership and/or possessory interests therein. The invention has application, by way of non-limiting example, to the (re)sale, lending or other transfer of ownership and/or possessory interests in digital books or other digital media objects for which acquisition, display, playing and/or other use is facilitated by special-purpose software and/or digital rights management (DRM) or other codes.

U.S. patent application Ser. No. 13/406,237, filed Feb. 27, 2012, and corresponding PCT Patent Application Serial No. PCT/US2012/026,776 (now, Publication No. WO 2012/116365), all entitled “Methods And Apparatus For Sharing, Transferring And Removing Previously Owned Digital Media,” the teachings of which are incorporated by reference herein, disclose methods, apparatus and systems suitable for the (re)sale or other transfer of digital media objects which methods and apparatus include, inter alia, atomically transferring ownership of those objects so that at no instant in time are copies of them available to both buyer and seller—but, rather, may be available only to the seller prior to sale and only to the buyer after sale. While those techniques can be effective, e.g., for the (re)sale, lending or other transfer of ownership and/or possessory interests in many digital media objects, further improvements are desirable in this regard for digital books or other digital media objects for which acquisition, display, play and/or other use is facilitated by special-purpose software and/or digital rights management (DRM) or other codes.

An object of this invention is to provide improved methods, apparatus and systems for digital data processing.

A related object is to provide such methods, apparatus and systems as are suitable for digital media handling.

Another object is to provide such methods, apparatus and systems as facilitate the (re)sale, lending or other transfer of ownership and/or possessory interests in digital books and other digital media objects.

Yet still further aspects of the invention is to provide such methods, apparatus and systems as facilitate such transfer of digital books and/or other digital media objects for which acquisition, display, play and/or other use is facilitated by special-purpose software and/or digital rights management (DRM) or other codes.

### SUMMARY OF THE INVENTION

The foregoing are among the objects attained by the invention, which provides in some aspects a digital data system that includes a first digital data device that, in order to transfer a digital media object to a second digital data device, transfers to that second digital data device a virtual machine embodying that digital media object. Those digital data devices may be, according to aspects of the invention, any of mainframe computers, minicomputers, workstations, desktop computers, portable computers, tablet computers, smart phones, personal digital assistants, eReaders, video consoles, movie players and other dedicated digital data devices. And, according to further aspects of the invention, the digital media object comprises a creative work, such as, by way of non-limiting example, a song, video, movie, book, story, article, document, still image, video game, software, or combination thereof.

Related aspects of the invention provide a system, e.g., as described above, in which the first digital data device transfers the virtual machine to the second digital data device over a network, e.g., as part of an e-commerce transaction for the sale, lending or other transfer of a ownership or possessory interest in digital media object embodied in the virtual machine.

According to other related aspects of the invention, there is provided a system, e.g., as described above, in which acquisition, display, play and/or other use of the digital media object is facilitated by special-purpose software and/or digital rights management (DRM) or other codes. And, commensurately, per those aspects of the invention, the digital media object embodies such software and/or digital rights management (DRM) or other codes.

Other aspects of the invention provide a system, e.g., as described above, in which the virtual machine embodies any of a web browser and an app suitable for any of acquiring, displaying, playing and/or otherwise using the digital media object. The virtual machine may embody, in still other related aspects of the invention, an interface that conveys, directly or indirectly, to a display screen or other output functionality of the first digital data device audio, video and/or other output generated by the web browser or app.

Still yet other aspects of the invention provide a system, e.g., as described above, in which the virtual machine embodies codes required for the acquisition, display, play and/or other use of the digital media object. Those codes may be based on information about a hardware and/or software platform emulated by the virtual machine—e.g., a digital data device other then the first digital data device. Those codes may be, according to still other aspects of the invention, any of account IDs, decryption keys, authorized hardware device IDs, MAC addresses, authorized software player IDs, and software application serial numbers.

Related aspects of the invention provide a system, e.g., as described above, wherein the virtual machine embodies an interface that conveys, directly or indirectly, to a display screen or other output functionality of the first digital data device audio, video and/or other output generated by software executing within the virtual machine that any of acquires, displays, plays and/or otherwise uses the digital media object—which software, itself, may be embodied in the virtual machine.

Other related aspects of the invention provide a system, e.g., as described above, wherein the virtual machine embodies an interface that conveys, directly or indirectly, to software executing within the virtual machine that any of acquires, displays, plays and/or otherwise uses the digital media object, any of mouse clicks, keyboard taps or other input provided by any of an owner or operator of the first digital data device. Again, here too, in related aspects of the invention, the virtual machine may embody that software, too.

The invention provides, in other aspects, a system as described above in which the the first digital data device that executes a virtual machine that (i) emulates at least one of: an aspect of a hardware and/or software platform of other than the first digital data device, and an action that could otherwise be performed by an owner and/or operator of that other device, and (ii) embodies a digital media object requested by any of an owner or operator of that second digital data device.

In related aspects, the invention provides methods paralleling operations of the systems described above.

The foregoing and other aspects of the invention are evident in the text that follows and in the drawings.

### BRIEF DESCRIPTION OF THE DRAWINGS

A more complete understanding of the invention may be attained by reference to the drawings, in which:

FIG. 1 depicts an e-commerce or other digital data system of the type with which the invention may be practiced;

FIG. 2 depicts utilization of the system of FIG. 1 for download to client devices and storage thereon of digital media objects and accompanying software and/or codes from servers of authorized sellers and/or distributors; and

FIGS. 3 and 4 depict systems according to the invention that facilitate the (re)sale, lending, other transfer of e-books or other digital media objects by embodying them in virtual machines.

### DETAILED DESCRIPTION OF THE ILLUSTRATED EMBODIMENT

### System Architecture

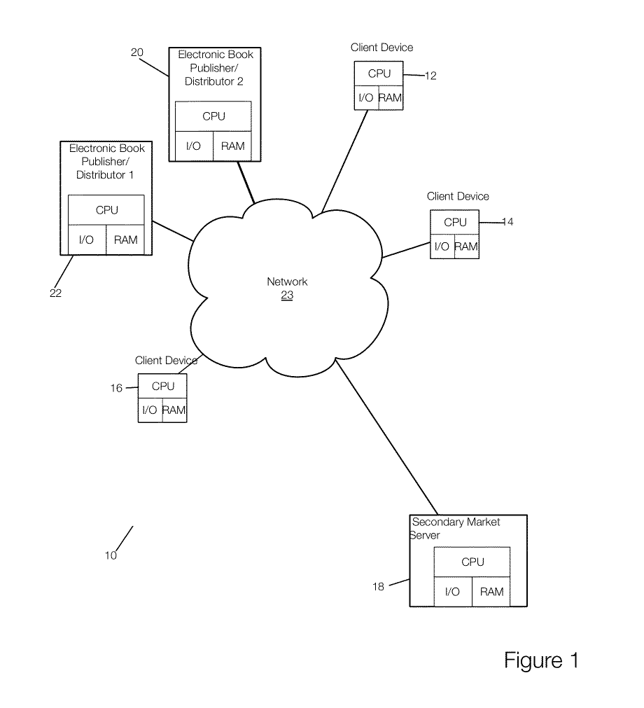

FIG. 1 depicts an e-commerce or other digital data system 10 of the type with which the invention may be practiced. The illustrated system includes one or more client digital data devices 12-16 and one or more server digital data devices 18-22, all of the type commercially available in the marketplace—as adapted in accord with the teachings hereof—and each including CPU, I/O and memory (RAM) subsections, by way of non-limiting example, for facilitating adaptation and communications in accord herewith.

The digital data devices 12-22 may be connected for communications permanently, intermittently or otherwise by a network, here, depicted by “cloud” 23, which may comprise an Internet, metropolitan area network, wide area network, local area network, satellite network, cellular network, and/or a combination of one or more of the foregoing, as adapted in accord with the teachings hereof. And, though shown as a monolithic entity in the drawing, in practice, network 23 may comprise multiple independent networks or combinations thereof.

Client digital data devices 12-16 operate in the conventional manner known in the art as adapted in accord with the teachings hereof with respect to the acquisition, displaying, playing and/or other use of “digital media objects” embodying creative works, such as by way of non-limiting example, digital songs, videos, movies, electronic books, stories, articles, documents, still images, video games, other software, and/or combinations of the foregoing—just to name a few. The client digital data devices typically comprise desktop computers, portable computers, tablet computers, smart phones, personal digital assistants, eReaders, video consoles, movie players and other dedicated digital data devices, or other computer apparatus of the type commercially available in the marketplace, as adapted in accord with the teachings hereof, though other devices such as mainframe computers, minicomputers, workstations may be employed as client digital data devices as well (again, so long as adapted in accord with the teachings hereof).

As used herein a digital media object (or “DMO”) refers to a collection of bits or other digital data embodying a creative work, such as, for example, a song, video, movie, book, game, computer app or program, just to name a few. Those bits are usually organized as a computer file, but they can be organized in other ways, e.g., in object-oriented class instances, structs, records, collections of packets, and so forth. The bits of a DMO at any time can be represented on some physical storage, either volatile or non-volatile, but they always represent the same creative work (excluding, as persons of ordinary skill in the art will appreciate, tags and other metadata, e.g., reflecting DMO ownership, distribution source(s), title and other biographical information, and so forth).

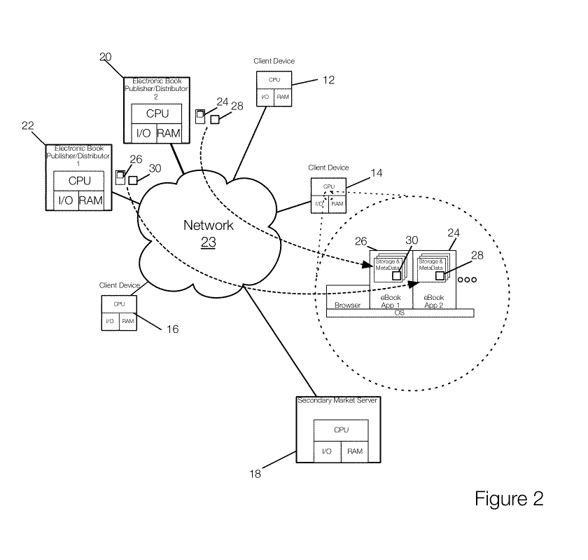

By way of further non-limiting example, client digital data devices 12-16 hereof may operate—albeit, as adapted in accord with the teachings hereof—in the manner of “computer 22” (by way of example) described in co-pending, commonly-assigned U.S. patent application Ser. No. 13/406,237, filed Feb. 27, 2012, and corresponding PCT Patent Application Serial No. PCT/US2012/026,776 (now, Publication No. WO 2012/116365), all entitled “Methods And Apparatus For Sharing, Transferring And Removing Previously Owned Digital Media” (collectively, “Applicant's Prior Applications”) and, more particularly, by way of non-limiting example, in FIGS. 2, 3A and 5 of those applications and in the accompanying text thereof.

Server 18 is a server device of the type employed by a service operator of the type that facilitates the (re)sale, lending or other transfer of digital music, digital books or other digital media objects. By way of non-limiting example, it may operate in the manner of the ReDigi™ commercial marketplace currently operating at www.redigi.com, as adapted in accord with the teachings hereof Alternatively, or in addition, it may operate in the manner of “remote server 20” described in FIGS. 2, 3A and 5 of Applicant's Prior Applications and in the accompanying text thereof, again, as adapted in accord with the teachings hereof. The server digital data device 18 typically comprises a mainframe computer, minicomputer, or workstation of the type commercially available in the marketplace, as adapted in accord with the teachings hereof, though other devices such as desktop computers, portable computers, tablet computers, smart phones, personal digital assistants, eReaders, video consoles, movie players and other dedicated digital data devices, or other computer apparatus may be employed as server 18, as well (again, so long as adapted in accord with the teachings hereof).

Servers 20-22 are server devices of the type employed by electronic music, electronic book and other digital media sellers and distributors of the type known in the marketplace, such as Amazon's same-named retail web site, Apple's iTunes website, Barnes & Noble's Kindle website, to name just a few. In the illustrated embodiment, those servers download (e.g., upon purchase request or otherwise) to devices 12-18 music files, digital books, video files, games and other digital media objects. Such downloads can be accomplished in the conventional manner known in the art, e.g., using web browsers or special-purpose apps. The server digital data devices 20-22 typically comprise mainframe computers, minicomputers, or workstations of the type commercially available in the marketplace, though other devices such as desktop computers, portable computers, tablet computers, smart phones, personal digital assistants, eReaders, video consoles, movie players and other dedicated digital data devices or other computer apparatus may be employed as server digital data devices 20, 22, as well. In the illustrated embodiment, the servers 20, 22 are assumed be of the type commercially available and operating in the marketplace. In some embodiments, those servers are modified in accord with the teachings hereof.

Although servers 18 and 20-22 are drawn separately in the illustrated embodiment, it will be appreciated that in some embodiments their functions and that, moreover, they may be operated by a single party—for example, that serves both as a seller or distributor of digital media, as well as a service operator that facilitates the (re)sale, lending or other transfer of such media. Likewise, though shown separately, here, in some embodiments the functions of any of the client devices 12-16 may be combined with those of any of servers 18-22.

### Downloading and Playing Digital Media Objects

The acquisition, display, playing and/or other use of digital books and other digital media objects often requires special-purpose software and/or digital rights management (DRM) or other codes (account IDs, decryption keys, authorized hardware device IDs such as MAC addresses or machine IDs, authorized software player IDs such as software application serial numbers, user names, and so forth, just by way of example). In reflection thereof, FIG. 2 depicts the download, to client devices 12-16 and storage thereon of such digital books or other digital media objects and the accompanying software and/or codes, from servers 20, 22 of authorized sellers and/or distributors. This is shown here, for sake of simplicity and by way of nonlimiting example, by way of such downloads to client digital data device 14.

In FIG. 2, the digital media objects are digital books or “e-books” (terms which are used interchangeably herein), and the special-purpose software and/or digital rights management (DRM) or other codes for digital book-type digital media objects comprise e-book reader apps 24-26 of the type commercially available from e-book distributors, such as Amazon and Barnes & Noble, along with accompanying codes that make possible display, play and/or other use of authorized digital books with those apps. In other embodiments they may comprise commensurate players and accompanying codes for other digital media objects. The special-purpose software, which is typically referred to here by reference to apps 24-26, executes under the operating system (labelled, here, as “OS”) native to the executing device, though, in other embodiments, that special-purpose software or those apps 24-26 may operate under a web browser.

Moreover, in some embodiments, that special-purpose software is not particular to any type, creator and/or other source of the digital media objects but, rather, comprises conventional MP3 players, web browsers and other media players available in the art. The term “web browsers” is used herein to collectively refer to these softwares.

And, though illustrated and described here as being downloaded together, digital books or other digital media objects and the accompanying special-purpose software and/or digital rights management (DRM) or other codes required for the acquisition, display, play and/or other use thereof need not be downloaded together nor from a common source. Thus, for example, the special-purpose software may be pre-installed on client or other digital data devices (as in the case of, for example, apps pre-installed on Kindle™ and Nook™ personal reading devices) or separately downloadable to it (e.g., as in the case of the Kindle™ and Nook™ apps available from Android, Amazon, Apple, or other “app stores”), yet, the digital rights management (DRM) or other codes required for the display, play and/or other use of a given digital book or other digital media object with such special-purpose software may be subsequently downloadable with that digital book or other digital media object itself, e.g., upon purchase thereof from an authorized seller or other distributor. Indeed, while some of those codes may be sourced by an authorized seller or distributor of the digital books or digital media objects themselves, others of those codes may derive from the device to which the digital book or digital media object is downloaded, for example, as in the case of authorized hardware device IDs, such as MAC addresses or machine IDs, and authorized software player IDs such as software application serial numbers, by way of example).

For simplicity, such is the assumption in the drawings and text that follows, i.e., that the digital books or other digital media objects 28, 30 include the digital rights management (DRM) or other codes required for their display, play and/or other use on special-purpose or other software, such as web browsers or player apps 24, 26, which themselves may be downloaded separately.

Regardless, referring to FIG. 2, digital books 28, 30 downloaded from servers 20, 22 of the illustrated embodiment to device 14 (again, by way of example) are shown stored with their respective apps 24-26—here, in an associated storage area labeled, “Storage & Media” on the device 14. In other embodiments, those digital media objects 28, 30 may be stored elsewhere on the client device 14, on physically attached volumes (e.g., flash-disks, “thumb” drives, and so forth), on logically attached volumes, on associated devices (e.g., other digital data devices owned by the owner device 14), on remote storage, streaming or other digital data devices that are in communications coupling with the client device 14—for example, in an account and/or storage area associated with device 14 or the owner/operator thereof on server 18 or other network-connected or cloud digital data devices—or otherwise.

Utilizing Virtual Machines to Facilitate the Transfer and Display, Play and/or Other Use of Digital Media Objects

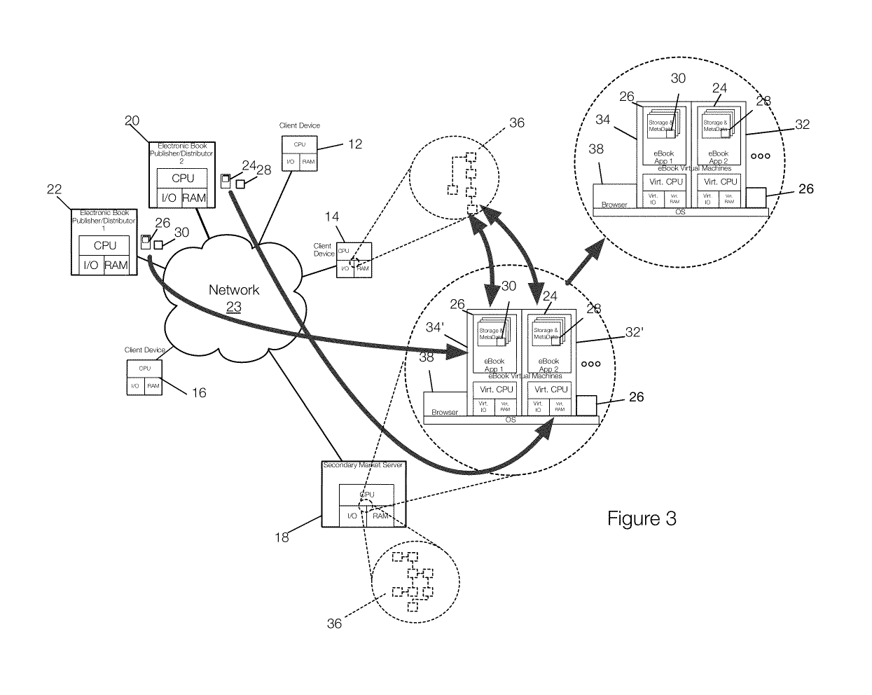

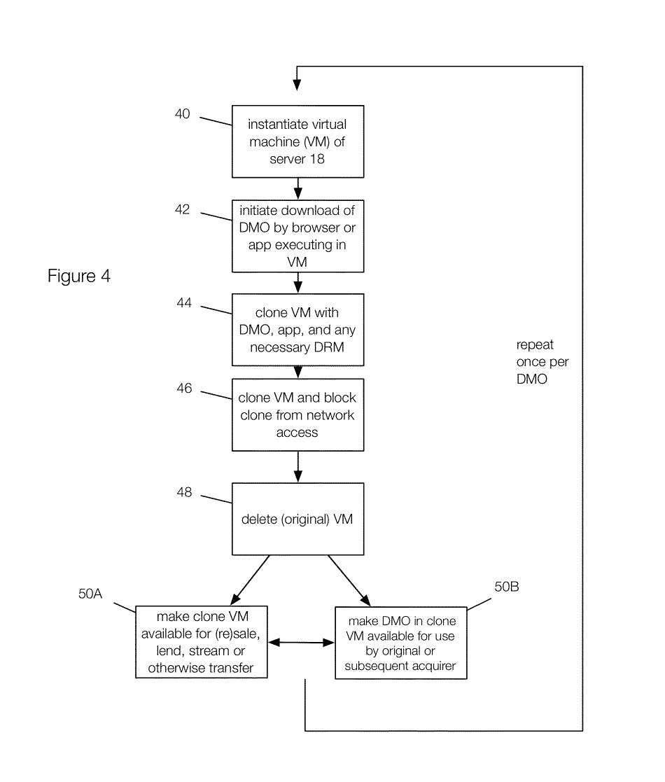

Referring to FIGS. 3 and 4, e-commerce or other digital data systems 10 according to the invention include one or more digital data devices, e.g., client devices 12-16 and/or server devices 18-22, that facilitate the (re)sale, lending, other transfer of ownership and/or possessory interests in, display, play and/or other use of the e-books or other digital media objects by virtualizing them, i.e., by placing, packaging, or otherwise embodying (collectively, “embodying”) them in virtual machines (a/k/a “containers”) 32, 34 that (i) execute on one or more of those digital data devices, thereby, permitting display, play and/or other use (e.g., by local or remote users) of the e-books or other digital media objects, and/or (ii) are suitable for download or other transfer to others of those devices 12-22 to effect sale, lending or other transfer of a ownership and/or possessory interest in the e-books or other digital media objects that those virtual machines embody.

The virtual machines 32-34 of the illustrated embodiment include interfaces that convey, directly or indirectly, to a display screen or other output functionality of the respective digital data devices on which those machines 32-34 are executed, audio, video and/or other output generated by the respective app 24-26 or browser 38 during display, play and/or other use of the digital book (or other digital media object) embodied in that virtual machine file. Likewise, that interface conveys, directly or indirectly, to the respective app 24-26 or browser 38 mouse clicks, keyboard taps or other input provided by the user in connection with display, play and/or other use of the digital book (or other digital media object) embodied in that virtual machine file. Such conveyance can be between the respective virtual machine 32-34 and a local device 14 on which it is executing. It can also be between the respective virtual machine 32-34, e.g., executing on server 18, and a remotely disposed device (e.g., a client device 12-16).

In some embodiments, such virtualization is effected prior to sale and download of the e-books or other digital media objects, e.g., from servers 20, 22 of authorized digital media sellers and distributors. However, in the illustrated embodiment, virtualization is effected upon or subsequent to download of the digital media objects (e.g., e-books) and their respective apps to the client devices 12-16 and/or server 18.

In the illustrated embodiment, virtualization of digital media objects (e.g., e-books) is effected and/or otherwise facilitated by virtual machine manager logic 36 operating independently on client digital data devices 12-16, within virtual machines 24, 26 and server 18, though, more typically, is effected by cooperative action of such software modules 36. In some embodiments, the virtual machine manager software 36 comprises part of the “management system” or “management software” shown in FIGS. 2, 3A and 5 of Applicant's Prior Applications and described and referred to the accompanying text, e.g., under those names, as well as the names “Manager App. 23” “Manager Application,” and the like, the aforesaid teachings of which prior applications are incorporated herein by reference.

In other embodiments, the virtual machine management software 36 of each device 12-18 is a stand-alone module and/or forms part of the operating system, filesystem, middleware, application layer, or other layers of the software stack of the respective devices 12-18. And, though in the illustrated embodiment the virtual machine management software module 36 does not execute on servers 20, 22, in other embodiments it may execute there, as well, in order to further facilitate utilization of virtual machines to facilitate (re)sale, lending, other transfer of ownership and/or possessory interests in, display, play and/or other use of the e-books or other digital media objects in accord with the teachings hereof.

The virtual machine management software 36 can interoperate with other software executing on the respective devices 12-22, as well as on the respective virtual machines 24,26. Thus, for example, the virtual machine management software 36 executing on the client devices 12-16 typically interoperates with web browsers 38, apps 24,26, and/or other functionality that are utilized to acquire, transfer, display, play or otherwise use DMOs, or otherwise. The virtual machine management software 26 may also interact with the operating system, file system, or other components of the respective devices and/or virtual machines.

Moreover, the virtual machine management software 36 can implement or otherwise support the aforementioned interfaces (hereinafter, referred to as the “aforesaid interfaces”) that (i) convey to a display screen or other output functionality, direct or indirect, of the respective digital data devices audio, video and/or other output generated by a respective app 24-26 during display, play and/or other use of the digital book (or other digital media object) embodied in that virtual machine file, and/or (ii) that convey to the respective app 24-26 mouse clicks, keyboard taps or other input provided by the user in connection with display, play and/or other use of the digital book (or other digital media object) embodied in that virtual machine file.

The construction and operation of logic 36, which is typically implemented in software (though, which may be implemented in hardware or otherwise) and which typically utilizes messaging, remote procedure calls, or otherwise, to communicate with other software or logic, will be evident to those of ordinary skill in the art in view of the teachings hereof

### Example

### Virtualizing Newly Acquired Digital Machine Objects Downloaded from Distributor/Seller Servers

FIGS. 3-4 depict actions of virtual machine manager(s) 36 on one or more of the digital data devices 12-22 to effect virtualization of an e-book or other digital media object 28. Typically the virtual manager(s) 36 effect those actions in response to a request by a client digital data device on behalf of an owner and/or operator thereof to acquire an e-book or other digital media object 28 from a server digital data device of the type employed by electronic music, electronic book or other digital media sellers and distributors of the type known in the marketplace. However, the virtual manager(s) 36 may also effect those actions in response to such requests by a server digital data device (on behalf of an owner and/or operator thereof or otherwise) to a client digital data device; by and between server digital data devices 18-22 (and, more particularly, the owners and/or operators thereof or otherwise); by and between client digital data devices 12-16 (and, more particularly, the owners and/or operators thereof); and so forth, all by way of non-limiting example.

A benefit of such virtualization is that not only does it facilitate acquisition, display, play and/or other use of the embodied digital books or other digital media objects, but it also facilitates the (re)sale, lending, or other transfer of ownership and/or possessory interests in the digital media object 28 and particularly, by way of non-limiting example, such digital media objects for which acquisition, display, play and/or other use is facilitated by special-purpose software and/or digital rights management (DRM) or other codes.

The embodiment of FIGS. 3-4 utilizes cooperative actions of the virtual manager(s) 36 of client digital data device 14 (by way of example) and server digital data device 18 (by way of example) to effect virtualization of an e-book or other digital media object 28 (by way of example) requested for acquisition or other transfer by an owner and/or operator of that client digital data device 14 from server digital data device 20.

In step 40, virtual machine manager 36 executing on server 18 creates a virtual machine 32′ that
(i) emulates any of
   at least an aspect of the hardware and/or software platform that requested acquisition or other transfer of the e-book or other digital media object 28, i.e., in this instance, digital data device 14, and/or
   an action that could otherwise be performed by an owner and/or operator of that device with respect to such acquisition or other transfer, and/or
(ii) is suitable for execution on server 18 itself—and, preferably, is suitable for execution on a variety of software and hardware platforms to which that virtual machine might otherwise be transferred for execution (e.g., other server or client digital data devices).

To this end, manager 36 utilizes Parallels, VMware, XEN or other virtualization software available in the marketplace to create the virtual machine 32′ (which, typically, is contained within a digital file, but which may be contained in another digital construct, as common in the art—as adapted in accord with the teachings hereof) and, preferably, pre-loads that virtual machine 32′, upon creation, with one or more (and, preferably all) of the following:
web browser 38
if available, app 24 suitable for acquiring and/or displaying, playing and/or otherwise using DMO 28
the aforesaid interfaces;
codes such as authorized hardware device IDs (e.g., MAC addresses or hardware IDs) and/or authorized software player IDs (e.g., software application serial numbers) that are based on information about the hardware and/or software platform at least an aspect of which is emulated by the virtual machine 32′ (i.e., in this instance, digital data device 14) and/or user names, account IDs, and so forth, that are based on information about an owner and/or operator of a device on which that platform is implemented, and which codes may be required for the display, play and/or other use of the requested e-book or other digital media object—which codes and/or other information virtual machine managers 36 executing on device 14, device 18 and/or virtual machine 32′ can cooperatively retrieve from device 14, and/or, —other functionality to be utilized to acquire, transfer, display, play and/or otherwise use the DMO 28.
   In addition, manager 36 of device 18 preferably preloads that virtual machine 32′ with its own virtual machine manager 36.

In step 42, virtual machine managers 36 executing on device 18 and virtual machine 32′ cooperatively initiate action by browser 38 and/or app 24 (if available) executing on virtual machine 32′ to acquire or otherwise transfer the e-book or other digital media object 28 requested by the owner and/or operator of client digital data device 14—and, thereby, to cause the e-book or other digital media object 28 to be placed, packaged or otherwise embodied in that virtual machine, along with accompanying software and/or digital rights management (DRM) or other codes (account IDs, decryption keys, authorized hardware device IDs such as MAC addresses or hardware IDs, authorized software player IDs such as software application serial numbers, usernames, and so forth, just by way of example) that may be downloaded with them.

That request can be signaled by the owner/operator to the server 18 and, more particularly, to virtual machine manager 36 executing thereon, via a browser or special-purpose software (not shown) or other functionality that executes on client device 14 that is in communications coupling with the server 18 and/or its virtual machine manager 36. Alternatively or in addition, virtual machine manager 36 (or other functionality) executing on device 14 can intercept and forward to server 18 and/or its virtual machine manager 36 a request made, via browser, app or otherwise, by the owner/operator of device 14 to the server 20 for acquisition or other transfer of such e-book or other digital media object 28.

In order to initiate action by browser 38 and/or app 24 (if available) executing on virtual machine 32′ to acquire or otherwise download the requested e-book or other digital media object 28—along with the app 24 (e.g., if not already available within the virtual machine 32′) and DRM or other codes necessary and/or useful for the display, play and/or other use of that DMO 28—one or both of virtual machine managers 36 executing on device 18 and virtual machine 32′ can, via script or otherwise, effect operation of that browser 38 or app 24 (if available) to take one of more of the following actions: (i) log into the aforesaid owners and/or operator's account on server 20, (ii) choose for acquisition or other transfer the e-book or other digital media object 28, (iii) effect payment therefor from the aforesaid account, and (iv) initiate download of that e-book or other digital media object 28 to the browser 38 or app 24 executing within virtual machine 32′ and, thereby, to effect embodying of the that digital media object within that virtual machine.

Alternatively or in addition, one or both of the virtual machine managers 36 executing on device 18 and virtual machine 32′ can utilize the aforesaid interfaces to allow the owner/operator of device 18 to control the browser 38 and/or app 24 (if available) executing within virtual machine 32′ to take one or more of the aforesaid actions. Such control can be effected by “remote desktop” functionality (not shown) executing on client device 14 and in communications coupling with browser 38 or app 24 (if available) executing on virtual machine 32′, e.g., via one or more of the virtual machine managers 36 or otherwise. Such remote desktop functionality can be of the type commercially available in the marketplace (e.g., so-called VNC or RDP software, by way of non-limiting example), as adapted in accord with the teachings hereof.

To recap, in the illustrated embodiment, virtual machine 32′ (and the clone 32 generated from it, as discussed below) can include not only the digital books or other digital media objects, but also the digital rights management (DRM) or other codes, if any, required for the acquisition, display, play and/or other use of them (i.e., the digital media objects) on web browsers and/or special-purpose software, one or both of which may also be included in the virtual machines. This may include, by way of example, account IDs, decryption keys, e.g., provided by authorized sellers or distributors of the digital media objects. These may also include authorized hardware device IDs, e.g., MAC addresses, authorized software player IDs, e.g., software application serial numbers, and so forth, whether sourced by such authorized sellers or distributors or derived from an authorized hardware and/or software platform emulated by the virtual machine.

In step 44, once the download is complete, the virtual machine manager executing on server 18 clones the virtual machine 32′ which, by virtue of steps 40-42, includes the requested e-book or other digital media object 28, browser 38 and/or app 24 suitable to display, play and/or otherwise use that DMO 28, and DRM or other codes necessary and/or useful for the display, play and/or other use of that DMO 28 The server 18 or the virtual machine manger 36 executing thereon can, then, take the cloned virtual machine 32 selectively “off line”—that is, it can block it from network access to server 20 (as well, for example, to “license servers,” as discussed below) whence the acquisition or other transfer was made.

In step 46, once the virtual machine 32 is offline, virtual machine managers 36 executing on device 18 and virtual machine 32′ cooperatively initiate action by browser 38 and/or app 24 executing on that virtual machine to delete the downloaded e-book or other DMO 28 from the account on server 20 from (or in connection with which) that DMO 28 was acquired or otherwise downloaded. The virtual machine manager(s) 36 can accomplish this, via script or otherwise, by effecting operation of that browser 38 and/or app 24 to take one of more of the following actions: (i) log into the operator's account on server 20, (ii) identify e-book or other digital media object 28 in account history, and (iii) delete that e-book or other DMO 28 from that history. Alternatively or in addition, one or both of those virtual machine managers 36 can utilize the aforesaid interfaces to allow the operator of device 18 to control the browser 38 or app 24 in taking one or more of these actions. As above, such control can be effected by “remote desktop” functionality (not shown) executing on device 18 and in communications coupling with browser 38 or app 24, e.g., via one or more of the virtual machine managers 36 or otherwise.

In instances where the digital media object 28 requested by the owner and/or operator of client digital data device 14 comprises a “high end” software application or other work the operation of which requires communication with a license server (not shown) or other networked instrumentality (collectively, for simplicity, “license server”), the virtual machine manager(s) 36 can accomplish this, via script or otherwise, e.g., in Step 44, by effecting operation of the software application or other work to initiate execution and obtain such licenses or other codes and, further, for preventing that application or other work from returning them (i.e., the licenses or other codes). The virtual machine manager(s) 36 can effect the latter, e.g., by blocking communications from the software application or other work to the license server before any such return of the license or other codes. Alternatively or in addition, the virtual machine managers 36 can utilize the aforesaid interfaces to allow the owner/operator to control the software or other work executing within virtual machine 32′ to take one or more of the aforesaid actions.

In step 48, the virtual machine manager 36 executing on device 18 destroys the virtual machine 32′, leaving its clone, virtual machine 32 intact and with the downloaded e-book or other DMO 28, app 24, the aforesaid interfaces, and DRM or other codes necessary and/or useful for the display, play and/or other use of that DMO 28 still stored therein.

In steps 50A and 50B, the digital object 28 virtualized in cloned virtual machine 32 may be made available for (re)sale, lending, or other transfer (per step 50A), display, playing and/or other use by the original or acquirer (per step 50B). Either or both of those steps are optional and/or both or either may be exercised repeatedly and in any order, e.g., as the virtual machine 32 and the digital media object embodied therein are (re)sold, lent, displayed, played and/or otherwise used by one or more owners and/or successive owners thereof.

In step 50A, for example, the cloned virtual machine 32 is transferred to another digital data device, e.g., that owned by the owner/operator's whose request for the digital book or other digital media object 28 embodied therein led to creation of the cloned virtual machine 32 (in this case, client digital data device 18) or to another digital data device—and/or from one such digital device to another such digital device, at the behest of the owners and/or operators thereof, or otherwise.

Like a digital media object, the cloned virtual machine 32 is typically organized as a digital file and can be transferred as such. However, also like a digital media object, it can be organized in other ways, e.g., in object-oriented class instances, structs, records, collections of packets, and so forth, and, likewise, can be transferred as such. Accordingly, in practice, the cloned virtual machine 32—including, the digital book or other digital media object 28 embodied therein, and one or more of the items discussed above embodied in the virtual machine 32′ from which virtual machine 32 was cloned, e.g., web browser 38, app 24 and/or other software suitable for acquiring and/or displaying, playing and/or otherwise using object 28, the aforesaid interfaces, the codes required for acquisition, display, play and/or other use of the requested e-book or other digital media object, and/or other functionality to be utilized to acquire, transfer, display, play and/or otherwise use that digital media object 28—is transferred to another digital data device by transfer of the file or other structures in which the virtual machine is contained or organized. A benefit of transferring the digital book or other digital media object in this manner is that not only does it facilitate display, play and/or other use of that digital book or other digital media object, but it also facilitates the transfer of ownership and/or possessory interests therein.

One preferred mechanism for transferring virtual machine 32 consistent with the foregoing is as part of an e-commerce transaction, or otherwise, utilizing techniques mirroring those described for files (or other structures) in which digital media objects are contained in Applicant's Prior Applications, the teachings of which are incorporated herein; though other e-commerce (or other) mechanisms may be employed as well or in addition.

In step 50B, the e-book or other digital media object embodied in cloned virtual machine 32 is made available for display, play and/or other use by the original or a subsequent owner/operator or other possessor. In the illustrated embodiment, this is effected by the steps of
(i) Utilizing the virtual machine manager 36 executing on device 18 to execute the cloned virtual machine 32,
(ii) Executing, within the cloned virtual machine 32, the aforesaid interfaces (and, as necessary, utilizing the virtual machine manager 36 executing within the cloned virtual machine 32 to invoke such execution)
(iii) Executing, on a digital data device of the owner/operator or other possessor, a browser, “remote desktop” or other functionality suitable for communication with the aforesaid interfaces to permit the owner/operator or other possessor to (a) experience on that digital data device output generated by the browser 38 and/or app 24 executing within cloned virtual machine 32 during display, play and/or otherwise use of the digital book or other digital media object 28 and/or (b) convey to that browser 38 and/or app 24 mouse clicks, keyboard taps or other input in connection with such display, play and/or other use of that digital book or other digital media object 28.

With reference to step (iii), in some embodiments of the invention, this step is performed by a special purpose application executing on the digital data device of the acquirer that not only affords such interfacing, but that also permits the owner/operator or other possessor to inventory, display, play and/or otherwise use, dispose of, transfer or otherwise manipulate all virtualized digital media objects associated with his/her account on server 18.

With continued reference to step (iii), to ensure adequate performance in instances where the virtual machine 32 embodies a gaming or other digital media object the display, play or other use of which involves rapid screen updates, rapid player input or otherwise, the aforesaid interfaces can employ compression or other techniques to minimize communications overhead between the digital media object 28 executing within the virtual machine 32 and the device on which the owner/operator or other possessor is experiencing such display, play or other use. This can better real-time display and/or responsiveness to owner/operator/possessor input, all by way of example, and thereby provide a better user experience.

And, with still further continued reference to step (iii), to ensure performance in instances where the virtual machine 32 embodies a software application or other digital media object 28 the operation of which requires communication with a license server (not shown) or other networked instrumentality (collectively, for simplicity, “license server”), the aforesaid interfaces can intercept communications attempted by the software application or other digital media object 28 to that license server and route them to a surrogate server (not shown) that simulates such response as would be expected and/or required by the software application or other digital media object, thereby, ensuring its operation. Expected responses for that surrogate server can be determined empirically, e.g., in connection with Step 44, above, by executing the software application or other digital media object 28 within virtual machine 32′ and monitoring its interactions with the license server. The pattern of those interactions and, particularly, the license server's responses can be maintained in the surrogate server for use in responding as described above.

In the illustrated embodiment, the virtual machine manager support virtualization of only one e-book or digital media object 28 per virtual machine 32. To that end, steps 40-50 are executed once for each such e-book or digital media object 28 requiring virtualization—e.g., in the example of FIGS. 3-4, each e-book or other digital media object acquired by the owner and/or operator of device 18 from the server 20. This is illustrated in FIG. 3, which depicts a cloned virtual machine 34, created utilizing the same such mechanism described above, to virtualize digital media object 30 requested for acquisition or other transfer by an owner and/or operator of device 14 from server 20.

### Example

### Virtualizing Previously Acquired Digital Machine Objects Downloaded from Distributor/Seller Servers

Described above in connection with FIGS. 3 and 4, is use of the illustrated embodiment to virtualize e-books or other digital media objects 28, 30 requested for acquisition or other transfer by an owner and/or operator of client device 14 from servers 20, 22. A similar mechanism may be employed to virtualize an e-book or other digital media object previously acquired by that owner/operator, with the following differences:
(i) In step 42, the virtual machine managers 36 initiate action by browser 38 and/or app 24 (if available) executing on virtual machine 32′ to download from server 20 a copy of the previously acquired e-book or other digital media object 28. Typically, this is in response to an explicit or inferred request by the owner/operator, signaled to the server 18 and/or the virtual machine manager 36 executing thereon, indicating that the owner/operator wishes to virtualize the previously purchased object 28. Depending on embodiment, an inferred request includes a request by the owner/operator to sell or otherwise transfer to object 28 to others, a request to upload the object 28 to server 18 for storage “in the cloud” or otherwise.
(ii) Also, in step 42, one or both of the virtual machine managers 36 executing on device 18 and virtual machine 32′ can, via script or otherwise, effect as “action (ii)” the step of designating that that virtual machine and/or the browser 38 and/or app 24 (if available) executing thereon as an “authorized” device of the owner/operator.
(iii) In step 44, the virtual machine managers 36 executing on device 18 and virtual machine 32′ can additionally cooperatively initiate action by browser 38 and/or app 24 (if available) executing on virtual machine 32′ to delete any electronic notes, bookmarks or other annotations associated with the digital book or other digital media object. This additional step is optional and only desired if the owner/operator desires to transfer the virtualized digital media object to others.
(iii) In step 46, a benefit of initiating action by browser 38 and/or app 24 executing on virtual machine 32′ to delete the downloaded copy of the e-book or other DMO 28 from the account on server 20 from (or in connection with which) that DMO 28 was acquired or otherwise downloaded is that it facilitates automatic deletion and/or invalidation of any other copies of the DMO 28 that may be associated with that account and that may stored on other devices of the owner/operator.

Described herein are systems and methods achieving the objects set forth above. It will be appreciated that the illustrated embodiments are merely examples of the invention and that other embodiments incorporating modifications thereto also fall within the scope of the invention. Thus, by way of non-limiting example, it will be appreciated that although the examples discussed above in connection with FIGS. 3-4 effect the e-book or other digital media object to be virtualized on server 18, like methods can be utilized to effect virtualization on a client digital data device and/or on another of the server digital data devices. And, by way of still further example, it will also be appreciated that the mechanisms taught herein can be used with (i) systems in which possession or transfer of a digital media object embodying a particular copy of a creative work can—like the possession or transfer of a physical object (e.g., a book, record album, DVD, etc.) embodying such a particular copy—reflect ownership or transfer thereof, as the case may be, of the digital media object and the particular copy embodied therein, (ii) systems in which ownership or the transfer thereof in a digital media object and/or the particular copy embodied therein or otherwise represented thereby is reflected by a central registry, by links, by pointers or otherwise, as well as with (iii) still other systems now or heretofore known in the art.

1. A digital data system comprising:
a first digital data device that, to transfer a digital media object to a second digital data device, transfers to that second digital data device a virtual machine embodying that digital media object.

2. The digital data system of claim 1, wherein the first digital data device and second digital data device comprise any of mainframe computers, minicomputers, workstations, desktop computers, portable computers, tablet computers, smart phones, personal digital assistants, eReaders, video consoles, movie players and other dedicated digital data devices.

3. The digital data system of claim 1, wherein the digital media object comprises a creative work.

4. The digital data system of claim 3, wherein the creative work includes any of a song, video, movie, book, story, article, document, still image, video game, software, or combination thereof.

5. The digital data system of claim 1, wherein the first digital data device transfers the virtual machine to the second digital data device over a network that includes an Internet, metropolitan area network, wide area network, satellite network, cellular network, and/or a combination.

6. The digital data system of claim 1, wherein the first digital data device transfers the virtual machine to the second digital data device in order as part of an e-commerce transaction.

7. The digital data system of claim 6, wherein the e-commerce transaction is the sale, lending or other transfer of a ownership and/or possessory interest in digital media object embodied in the virtual machine.

8. The digital data system of claim 1, wherein acquisition, display, play and/or other use of the digital media object is facilitated by special-purpose software and/or digital rights management (DRM) or other codes, and the virtual machine embodies that software and/or digital rights management (DRM) or other codes.

9. The digital data system of claim 1, wherein the virtual machine embodies any of
a web browser, and
an app suitable for any of acquiring, displaying, playing and/or otherwise using the digital media object.

10. The digital data system of claim 9, wherein the virtual machine embodies an interface that conveys, directly or indirectly, to a display screen or other output functionality of the first digital data device audio, video and/or other output generated by the web browser or app.

11. The digital data system of claim 1, wherein the virtual machine embodies codes required for the acquisition, display, play and/or other use of the digital media object.

12. The digital data system of claim 11, wherein the codes are based on information about a hardware and/or software platform emulated by the virtual machine.

13. The digital data system of claim 11, wherein the platform emulated by the virtual machine is a digital data device other then the first digital data device.

14. The digital data system of claim 11, wherein the codes include any of account IDs, decryption keys, authorized hardware device IDs, MAC addresses, authorized software player IDs, and software application serial numbers.

15. The digital data system of claim 1, wherein the virtual machine embodies an interface that conveys, directly or indirectly, to a display screen or other output functionality of the first digital data device audio, video and/or other output generated by software executing within the virtual machine that any of acquires, displays, plays and/or otherwise uses the digital media object.

16. The digital data system of claim 15, wherein the virtual machine embodies said software.

17. The digital data system of claim 1, wherein the virtual machine embodies an interface that conveys, directly or indirectly, to software executing within the virtual machine that any of acquires, displays, plays and/or otherwise uses the digital media object, any of mouse clicks, keyboard taps or other input provided by any of an owner or operator of the first digital data device.

18. The digital data system of claim 17, wherein the virtual machine embodies said software.

19-23. (canceled)

24. A digital data system comprising:
a first digital data device that executes a virtual machine that
(i) emulates at least one of:
an aspect of a hardware and/or software platform of a second digital data device,
an action that could otherwise be performed by an owner and/or operator of the second digital data device, and
(ii) embodies a digital media object requested by any of an owner or operator of that second digital data device.

25-41. (canceled)

42. A method of digital data transfer, comprising the steps of transferring from a first digital data device to a second digital data device a virtual machine that embodies a digital media object.

43-104. (canceled)

105. A method for digital data transfer comprising:
embodying in a virtual machine of a first digital data device:
a digital media object,
software that, when executed on the virtual machine, any of acquires, displays, plays and/or otherwise uses the digital media object,
an interface, when executed on the virtual machine, at least one of:
conveys, directly or indirectly, to a display screen or other output functionality of the first digital data device audio, video and/or other output generated by said software, and
conveys, directly or indirectly, to said software any of acquires, displays, plays and/or otherwise uses the digital media object, any of mouse clicks, keyboard taps or other input provided by any of an owner or operator of the first digital data device,
codes accessible by any of said software and said interface when executed on the virtual machine, which codes are required for any of acquisition, display, play and/or other use of the digital media object,
emulating with the virtual machine at least one of:
an aspect of a hardware and/or software platform of a digital data device other than the first digital data device,
an action that could otherwise be performed by an owner and/or operator of that other digital data device, and
wherein the virtual machine embodies a digital media object requested by any of an owner or operator of that other digital data device

106-111. (canceled)
